(19) United States
(12) Patent Application Publication
(10) Pub. No.: US 2018/0136354 A1
(43) Pub. Date: May 17, 2018

(54) Sensor device and method for borehole seismic applications

(71) Applicant: Read AS, Hvalstad (NO)

(72) Inventor: Jakob B. U. Haldorsen, Nesbru (NO)

(21) Appl. No.: 15/737,330

(22) PCT Filed: Jun. 17, 2015
(86) PCT No.: PCT/EP2015/063521

§ 371 Date: Dec. 18, 2017

(51) Int. Cl. G01V 1/52; G01V 1/18; G01V 1/22; G01V 1/42

(52) U.S. Cl. CPC G01V 1/52; G01V 1/181; G01V 2210/161; G01V 1/42; G01V 1/226

(57) ABSTRACT

Method and device for performing vertical seismic profiling (VSP) in a borehole with a seismic device (10) comprising an elongated cable (20) with conductors (30) for transporting power and at least one communication line (40) for carrying signals. The device further comprises at least one connection point (50) placed along the elongated cable (20), where the connection point (50) comprises wireless power providing means (60) and communication means (65) that are connected to said conductors (30) and communication line (40) in the elongated cable (20), and at least one sealed seismic module (70) fixed to the at least one connection point (50), the seismic module (70) comprises a geophone (75), electronics (80) for detecting and transferring seismic signals, power receiving means (85) for wirelessly receiving power from the connection point (50) and means for wirelessly transmitting seismic signals to the communication line (40) via the communication means (65) comprised in the connection point (50).

### INTRODUCTION

The invention is within the technical field of seismic prospecting, and more specifically relates to a modular seismic device and method for performing vertical profiling in a borehole.

### BACKGROUND

There are several different sensor systems for borehole-seismic applications. Examples of such are cables with seismic sensors integrated in the cable or cables where the cable themselves are continuous sensors. The last mentioned can be provided by fiber optic cables providing distributed acoustic sensing (DAS) based on Rayleigh scattering for providing distributed strain sensing.

There is also a combination of the two different mentioned sensor systems described in WO 2014/199300 A2 (Kjos). The lower part of a seismic cable comprising seismic sensors and an upper part comprising a fiber optic cable which itself is a sensor and which also transfer signals from the sensors in the lower part. The distance between the sensors and the number of sensors comprised in these cables are fixed and can not be altered when such cables are provided for a specific seismic survey.

There is a need for a flexible and cost efficient seismic device that can be assembled on site and according to specific needs, and where the number of sensors used and the distance between them can be adjusted according to needs.

There are seismic modular systems made for surface seismic surveys. AnySeis™ is an example of a system designed for building inexpensive systems for recording acoustic signals transmitted through the ground. It uses a sensor house with electrical geophones for measuring signals and each receiver unit is provided with a digitizer and a communication module for communicating digital signal to a central recording unit. The communication and the operating power both come through a standard electrical dual-conductor electric power cord. The geophone is connected to the electric cord through two vampire-tap pins penetrating the cable insulation making electrical connection between the cable and the sensor unit.

With the external connection pins on the sensor house, the AnySeis™ system is not suited for downhole applications having harsh conditions with high pressures and temperatures.

The present invention suggests a solution where seismic signals are wirelessly transferred from a sensor house to a communication line in an elongated cable.

Wireless transferring of signals is well known in the field, and can be performed by for instance radio signals or induction such as near field communication (NFC).

In its simplest configuration the seismic profiling device according to the invention comprises an elongated cable placed in a borehole. Conductors for transporting power and at least one communication line are provided in the cable. Along the cable there are provided at least one connection point. This connection point comprises wireless power and communication providing means which are connected to the conductors and the communication line in the elongated cable. At least one sealed seismic module, comprising a geophone and electronics for detecting and transferring seismic signals, is fixed to the at least one connection point. By enclosing the seismic sensor system in a sealed module it is safely insulated and suited for being installed in harsh environments such as boreholes. Power supply and communication of signals can be enabled via wireless means over short distances between the seismic module and the connection point.

The same inductive or capacitive modules can be used for both communicating digital seismic signals at high frequencies and power at significantly lower frequencies. The diversity of the frequencies also allows the digitized signal and the electric power to be transmitted on the same electrical conductors, possibly reducing the minimum number of electrical conductors in the cable from three to two.

By providing the elongated cable with several connection points any number of sensors can be placed at any location while interacting with the communication line in the cable. This flexibility is possible due to self-supported seismic modules, wireless power supply to the modules and wireless transfer of seismic signals from the modules at any connection point along the cable.

Prior art seismic cables are provided with a fixed number of seismic sensors placed at fixed locations along a cable.

The device according to the invention can further be expanded to a hybrid VSP system by including an optical fibre and thereby combining near-continuous single-component DAS sensors measuring strain along the axis of fibres with three-component, sparsely-distributed three-component electric acoustic sensors fixed to selected connection points along the cable for providing information about the direction of propagation for components of the propagating acoustic wave field. The large-aperture image that can be derived from the DAS sensors is fully adequate when the formation includes only a limited dip range. For a full dip-range formation, the sparsely distributed three-component electric sensors will provide information about the azimuth direction of reflected acousto-elastic wave front, and therefore constrain the image of the formation derived from the acoustic measurements.

The device and method for performing seismic profiling according to the invention is both flexible and cost effective. The device can be adapted for a specific survey and can be reused from one survey with one set sensor geometry to another survey with different sensor geometry. The seismic device is further water tight and leakage free and provides a flexible solution for temporary or permanent installation.

### SHORT DESCRIPTION OF THE INVENTION

The present invention is defined by a seismic device for performing vertical seismic profiling in a borehole. The device comprises an elongated cable with conductors for carrying power and at least one communication line for carrying signals. The device is characterized in further comprising at least one connection point placed along the elongated cable, where the connection point comprises power providing means and communication means that are connected to said conductors and communication line in the elongated cable.

The device further comprises at least one sealed seismic module fixed to the at least one connection point, the seismic module comprises a geophone, electronics for detecting and transferring seismic signals, power receiving means for wirelessly receiving power from the connection point and means for wirelessly transmitting seismic signals to the communication line via the communication means comprised in the connection point.

The invention further comprises a method for performing vertical seismic profiling in a borehole. The method is defined in the claims.

Further features of the device and method are defined in the dependent claims.

### DETAILED DESCRIPTION OF THE INVENTION

The invention will now be described in detail with reference to the drawings where:

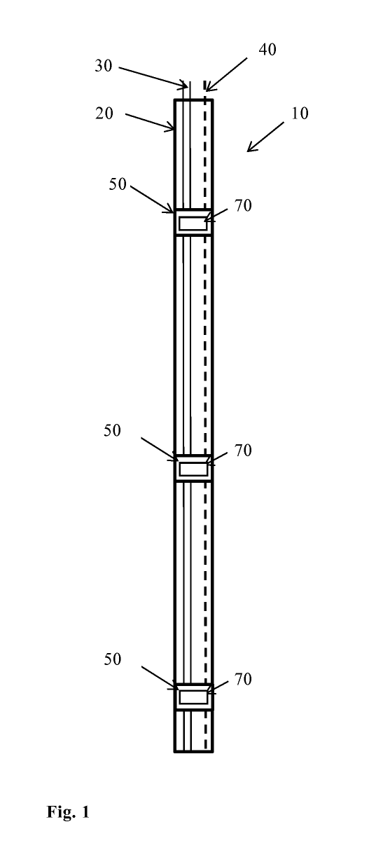

FIG. 1 illustrates the components comprised in the elongated cable for seismic profiling;

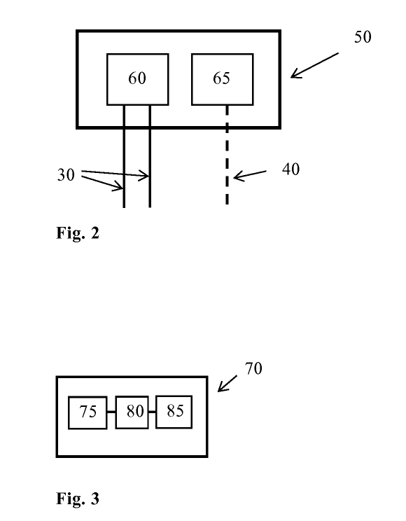

FIG. 2 illustrates the components comprised in one connection point along the elongated cable, and

FIG. 3 illustrates components comprised in a sealed seismic module.

FIG. 1 shows an illustration of one embodiment of the invention. The figure shows the seismic device 10 for performing vertical seismic profiling (VSP) in a borehole. The device comprises several components. One component is an elongated cable 20 with conductors 30 for carrying power and at least one communication line 40 for carrying signals. Along this cable 20 there are provided at least one connection point 50. The figure illustrates a seismic device 10 with three connection points. In other embodiments the seismic device 10 may be provided with less or more than three connection points 50.

FIG. 2 illustrates a single connection point 50 and its components. A connection point 50 comprises power providing means 60 and communication means 65 that are connected to said conductors 30 and communication line 40 in the elongated cable 20.

In its simplest configuration, the elongated cable 20 comprises only one connection point 50. In a preferred embodiment however, the elongated cable 20 comprises two or more connection points 50 placed at regular distances or intervals along the cable 20.

The intervals can be any interval. In one embodiment the distance between each connection point 50 is set to 3.75 meters along the cable 20. It is found that this distance between each connection point 50 provides flexibility with regards to use of same seismic device 10 for different types of seismic surveying.

The seismic device 10 further comprises at least one sealed seismic module 70 fixed to the at least one connection point 50.

FIG. 3 illustrates a sealed seismic module 70 and its components comprising at least a geophone 75 and electronics 80 for detecting and transferring seismic signals. In order to receive power it is also equipped with power receiving means 85 for wirelessly receiving power from the connection point 50. Analogue seismic signals from the geophone 75 are converted to digital signals in an A/D converter prior to being transmitted to the connection point 50.

The electronics 80 for transferring signals further comprises wireless transmission means for wirelessly transferring seismic signals to the communication line 40 in the elongated cable 20. This is enabled by the communication the means 65 comprised in the connection point 50. The communication line 40 can be a dual conductor cable, either twisted-pair- or coaxial cable.

In one embodiment the seismic module 70 may be equipped with a battery for backup purposes. This may be a rechargeable battery receiving power and being charged from the connection point 50. A battery included in the seismic module 70 will ensure that the seismic module 70 will function and produce seismic data event if power supply via the connection point 50 fails.

The power providing means 60 comprised in the connection point 50 is preferably transferring power wirelessly. This is possible by including inductive means in the connection point 50 as well as in the seismic module 70. It is well known that power can be transferred wirelessly from one device to another by using coils in each device to be connected, and where electromagnetic field is used for transferring energy wirelessly.

The communication means 65 for transferring signals between the seismic module 70 and the connection point 50 is inductive or capacitive communication modules comprised in the seismic module 70 as well as in the connection point 50. It may also be a combination of inductive or capacitive communication modules.

The same inductive or capacitive modules can be used for both communicating digital seismic signals at high frequencies and power at significantly lower frequencies. The diversity of the frequencies between the digitized signal and the electric power also allows the digitized signal and the electric power to be transmitted on the same electrical conductors, possibly reducing the minimum number of electrical conductors in the cable from three to two.

In one embodiment of the invention, the seismic device 10 comprises at least one optical fibre included in the elongated cable 20 for sensing seismic events along the cable 20. By including optical fibres in the communication cable it will allow nearly continuous single-component DAS recordings of strain along the axis of the fiber, further described in WO 2010136810 A2 (Farhadiroushan). With sparsely distributed three-component electrical sensors fixed to selected connection points 50 it will constitute a Hybrid VSP recording array along the total length of the elongated cable 20. The three-component sensors may be fixed to connection points 50 on cable 20 at suitable intervals, e.g., 7.5 m, 15 m, 18.75 m, 22.5 m, etc.).

If channel capacity of the system is a problem it is possible to introduce hubs along the cable for connecting to an Ethernet network, allowing for almost any number of channels.

The optical fibre may in one embodiment be connected to the at least one connection point 50 by fibre optical connection means known in the art. It can then provide double functionality by carrying both self produced DAS seismic signals as well as seismic signals received from each seismic module 70.

In addition to the seismic device 10 described above, the present invention further comprises a method for performing vertical seismic profiling in a borehole by installing an elongated cable 20 in the borehole.

The first step of the method is providing the cable 20 with conductors 30 for carrying power and at least one communication line 40 for carrying signals.

The next step is providing the cable 20 with at least one connection point 50 placed along the elongated cable 20. This connection point 50 comprises power providing means 60 and communication means 65 that are connected to said conductors 30 and communication line 40 in the elongated cable 20. The connection points 50 may in one embodiment be fixed at regular intervals along the cable 20, e.g. at 3.75 meter intervals.

In one embodiment of the method at least one optical fibre is provided in the elongated cable 20 for sensing seismic events along the total length of the cable 20. This may further be connected to one or more connection points 50, thus enabling the optical fibre to function as the communication line 40 for transferring seismic signals generated by the seismic module 70 in addition to transferring self-generated seismic signals.

The next step of the method is fixing at least one sealed seismic module 70 to the at least one connection point 50. A seismic module 70 comprises a geophone 75 and electronics 80 for detecting and transferring seismic signals. A seismic module 70 may be fixed to a connection point 50 by clamps or other physical fastening device. In one embodiment a seismic module 70 is fixed to a connection point 50 by inductive or capacitive means comprised in the seismic module 70 and in the at least one connection point 50. A combination of these may be preferable in case power is lost.

For a temporary installation, the elongated cable 20 and the at least one sealed seismic module 70 can be fixed to a casing in a borehole by well known electromagnetic or electro-mechanical means provided in the at least one or more connection points 50.

For a permanent installation of the seismic device 10, the elongated cable 20 and the at least one sealed seismic module 70 can be fixed to a casing in the borehole by cementing.

When the seismic device is installed in the borehole and assembled according the method described above, it is prepared and ready for wirelessly receiving power from the connection point 50 by the power receiving means 85 and wirelessly transmitting seismic signals from the seismic module 70 to the communication line 40 via the communication means 65 comprised in the connection point 50.

The present invention provides a flexible and cost effective seismic device 10 that can be assembled according to one configuration for a specific survey and reused and reconfigured for other surveys.

With optical fibres included in the elongated cable 20, the resulting hybrid system will provide both a large aperture from the near-continuous single-component DAS sensors and directional information from sparsely distributed three-component sensors. Such a hybrid system would thus enable the generation of high-resolution, full dip-range images for a full spatial aperture. Used for a VSP survey, the savings for a client in rig-time costs can be substantial as this survey can be performed without moving the receiver system.

1. Seismic device (10) for performing vertical seismic profiling (VSP) in a borehole, the device comprises an elongated cable (20) with conductors (30) for carrying power and at least one communication line (40) for carrying signals,
characterized in that the device (10) further comprises:
at least one connection point (50) placed along the elongated cable (20), where the connection point (50) comprises power providing means (60) and communication means (65) that are connected to said conductors (30) and communication line (40) in the elongated cable (20);
at least one sealed seismic module (70) fixed to the at least one connection point (50), the seismic module (70) comprises a geophone (75), electronics (80) for detecting and transferring seismic signals, power receiving means for (85) for wirelessly receiving power from the connection point (50) and means for wirelessly transmitting seismic signals to the communication line (40) via the communication means (65) comprised in the connection point (50).

2. Seismic device (10) according to claim 1, where the elongated cable (20) comprises two or more connection points (50) placed at regular intervals along the cable (20).

3. Seismic device (10) according to claim 1, where power supply for the seismic module (70) is inductive power providing means (60) comprised in the connection point (50) and in the seismic module (70).

4. Seismic device (10) according to claim 1, where the communication means (65) for transferring signals between the seismic module (70) and the connection point (50) is inductive and/or capacitive communication modules comprised in the seismic module (70) and in the connection point (50).

5. Seismic device (10) according to claim 1, where the elongated cable (20) comprises at least one optical fibre for sensing seismic events.

6. Seismic device (10) according to claim 5, where the optical fibre is connected to the at least one connection point (50) by optical connection means and is functioning as the communication line (40) for seismic signals generated by the seismic module (70) in addition to self-generated seismic signals.

7. Method for performing vertical seismic profiling (VSP) in a borehole by installing an elongated cable (20) in the borehole, the cable (20) having conductors (30) for carrying power and at least one communication line (40) for carrying signals, characterized in further comprising:
providing at least one connection point (50) placed along the elongated cable (20), where the connection point (50) comprises power providing means (60) and communication means (65) that are connected to said conductors (30) and communication line (40) in the elongated cable (20);
fixing at least one sealed seismic module (70) to the at least one connection point (50), the seismic module (70) comprises a geophone (75) and electronics (80) for detecting and transferring seismic signals;
wirelessly receiving power from the connection point (50) by power receiving means (85) and wirelessly transmitting seismic signals from the seismic module (70) to the communication line (40) via the communication means (65) comprised in the connection point (50).

8. Method according to claim 7, comprising fixing two or more connection points (50) at regular intervals along the cable (20).

9. Method according to claim 8, comprising fixing the connection points at regular intervals of 3.75 meters along the cable (20).

10. Method according to claim 7, further comprising providing at least one optical fibre in the elongated cable (20) for sensing seismic events.

11. Method according to claim 10, comprising connecting the optical fibre to the at least one connection point (50) by optical connection means enabling optical fibre to function as the communication line (40) for transfer seismic signals generated by the seismic module (70) in addition to self-generated seismic signals.

12. Method according to claim 7, comprising fixing the at least one seismic module (70) to the at least one connection point (50) by means of inductive means comprised in the seismic module (70) and in the at least one connection points (50).

13. Method according to claim 7, further comprising permanently installing the elongated cable (20) and the at least one sealed seismic module (70) to a casing in the borehole by cementing.

14. Method according to claim 12, further comprising temporary installing the elongated cable (20) and the at least one sealed seismic module (70) to a casing in the borehole by electromagnetic or electro-mechanical means in the at least one or more connection points (50).
